(19) United States
(12) Patent Application Publication
(10) Pub. No.: US 2015/0195048 A1
(43) Pub. Date: Jul. 9, 2015

(54) WIRELESS COMMUNICATION DEVICE WITH CIRCUIT ISOLATION

(71) Applicant: Lindsay Corporation, Omaha, NE (US)

(72) Inventors: Brant Alan Burkey, Denton, NE (US); Robert Dvorak, Lincoln, NE (US)

(73) Assignee: LINDSAY CORPORATION, Omaha, NE (US)

(21) Appl. No.: 14/148,244

(22) Filed: Jan. 6, 2014

(51) Int. Cl. H04B 15/02; A01G 25/16

(52) U.S. Cl. CPC H04B 15/02; A01G 25/16; H04W 88/02

(57) ABSTRACT

A wireless modem comprises an antenna, modem circuitry, a first galvanic isolation device, and a second galvanic isolation device. The antenna is configured to transmit and receive wireless signals and to communicate electronic transmit and receive signals. The modem circuitry is configured to convert transmit data from a data processing system to the electronic transmit signal for the antenna and to convert the electronic receive signal from the antenna to receive data for the data processing system. The first galvanic isolation device is configured to electrically isolate the electronic transmit and receive signals between the antenna and the modem circuitry. The second galvanic isolation device is configured to receive electrical power from the data processing system and supply isolated electrical power to the modem circuitry and to electrically isolate the transmit and receive data between the modem circuitry and the data processing system.

### BACKGROUND OF THE INVENTION

1. Field of the Invention

Embodiments of the current invention relate to wireless communication devices.

2. Description of the Related Art

Wireless communication devices, such as wireless modems, are used in a variety of applications to wirelessly transmit data to and from data processing systems. For example, an irrigation system may utilize one or more wireless communication devices to transmit irrigation data or statistics to and receive instructions or commands from an irrigation manager or a central monitoring station. Many wireless communication devices include a telecommunications network voltage (TNV) circuit, which under normal operating conditions carries telecommunication signals and is not directly connected to primary electrical power. In the wireless modem, the TNV circuit may send the signal to and receive the signal from an antenna.

Prior art wireless modems, such as the one shown in FIG. 1, require an isolator module to transmit and receive a telecommunications signal from a data processing system. In turn, the wireless modem transmits and receives an isolated telecommunications signal from the isolator module. In addition, the isolator module and the wireless modem each require a dedicated electrical power supply. The isolator module and the additional power supplies add cost to the wireless modem and consume space.

### SUMMARY OF THE INVENTION

Embodiments of the current invention solve the above-mentioned problems and provide a wireless modem that can be coupled to data processing systems without the need for external isolation modules. The wireless modem comprises an antenna, modem circuitry, a first galvanic isolation device, and a second galvanic isolation device. The antenna is configured to transmit and receive wireless signals and to communicate electronic transmit and receive signals. The modem circuitry is configured to convert transmit data from a data processing system to the electronic transmit signal for the antenna and to convert the electronic receive signal from the antenna to receive data for the data processing system. The first galvanic isolation device is configured to electrically isolate the electronic transmit and receive signals between the antenna and the modem circuitry. The second galvanic isolation device is configured to receive electrical power from the data processing system and supply isolated electrical power to the modem circuitry and to electrically isolate the transmit and receive data between the modem circuitry and the data processing system.

The wireless modem may be used with an irrigation system comprising a central pivot, a conduit, a plurality of mobile support towers, a plurality of truss sections, a plurality of drive motors, and an electronic control unit. The wireless modem is configured to wirelessly transmit data to and receive data from an external source. The central pivot is coupled to the conduit and is configured to supply water for irrigating. The mobile support towers, in combination with the truss sections, are configured to support the conduit. The drive motors are configured to control the movement of the mobile support towers. The electronic control unit includes a program configured to control operation of the drive motors. The electronic control unit is also in communication with the wireless modem to transmit and receive data regarding the program.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic block diagram of a prior art wireless modem system;

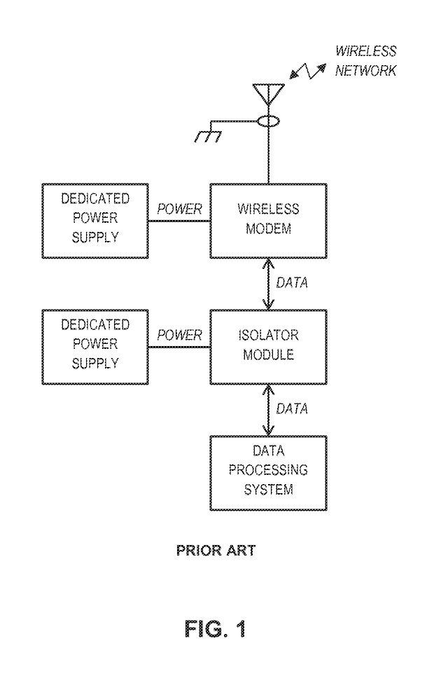

FIG. 2 is a schematic block diagram of a wireless modem constructed in accordance with a first embodiment of the current invention;

FIG. 3 is a perspective view of an irrigation system constructed in accordance with a second embodiment of the current invention; and

FIG. 4 is a schematic block diagram of a wireless modem and an electronic control unit of the irrigation system of FIG. 3.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

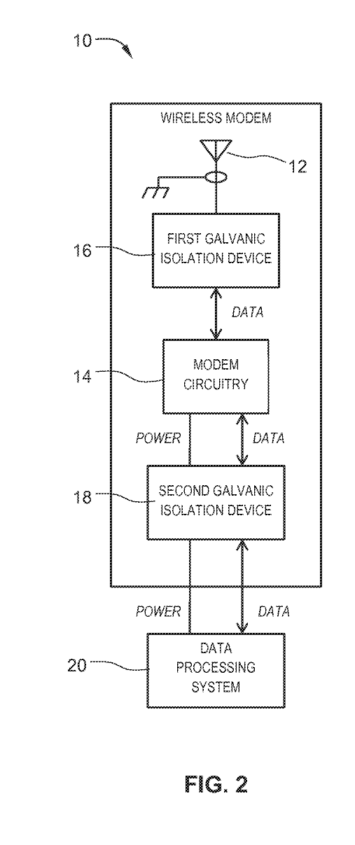

A wireless modem 10, constructed in accordance with a first embodiment of the current invention, is shown in FIG. 2. The wireless modem 10 may broadly comprise an antenna 12, a modem circuitry 14, a first galvanic isolation device 16, and a second galvanic isolation device 18. The wireless modem 10 may be in communication with a data processing system 20 such that the wireless modem 10 receives electrical power and transmits and receives data, such as telecommunications data, from the data processing system 20. Examples of the data processing system 20 include computers, electronic equipment, electro-mechanical machinery, or any other components or devices that need to wirelessly communicate data or instructions—often from a remote location.

The antenna 12 generally converts electrical energy into radio waves, and vice versa. The antenna 12 may include omnidirectional or unidirectional antennas. The antenna 12 may be in communication with the first galvanic isolation device 16 to receive an electronic transmit signal to be transmitted. The antenna 12 may also send an electronic receive signal to the first galvanic isolation device 16 which was received. Furthermore, the antenna 12 may have a connection to earth ground.

The modem circuitry 14 generally processes the signals from both the antenna 12 and the data processing system 20. The modem circuitry 14 may convert or transform the transmit data from the data processing system 20 to the electronic transmit signal to be transmitted on the antenna 12. The modem circuitry 14 may convert or transform the electronic receive signal from the antenna 12 to the receive data to be communicated to the data processing system 20. The modem circuitry 14 may include a telecommunications network voltage (TNV) circuit as well as oscillators, signal mixers, signal amplifiers, signal filters, and the like which may perform frequency upconversion, frequency downconversion, signal modulating, signal demodulating, signal encoding, signal decoding, and other communication functions. The modem circuitry 14 may be in communication with the first galvanic isolation device 16 in order to send and receive signals from the antenna 12. The modem circuitry 14 may be in communication with the second galvanic isolation device 18 such that the modem circuitry 14 receives electrical power and transmits and receives signals from the second galvanic isolation device 18.

The first galvanic isolation device 16 generally provides electrical isolation between two circuits. In various embodiments of the current invention, the first galvanic isolation device 16 provides electrical isolation between the modem circuitry 14 and the antenna 12. The first galvanic isolation device 16 may include transformers, optocouplers, opto-isolators, capacitive isolators, radio frequency (RF) isolators, and the like. The first galvanic isolation device 16 may be configured to communicate signals from the antenna 12 to the modem circuitry 14 and from the modem circuitry 14 to the antenna 12.

The second galvanic isolation device 18 generally provides electrical isolation between the modem circuitry 14 and the data processing system 20. The second galvanic isolation device 18 may utilize one or more transformers to transfer electrical power from the data processing system 20 to the modem circuitry 14. In some embodiments, the second galvanic isolation device 18 may utilize an isolation transformer with a primary that receives an AC voltage from the data processing system 20 and a secondary that supplies an AC voltage to the modem circuitry 14. In other embodiments, the second galvanic isolation device 18 may receive an AC voltage from the data processing system 20 and may supply a DC voltage to the data processing system 20. The second galvanic isolation device 18 may also be configured to communicate isolated signals from the modem circuitry 14 to the data processing system 20 and from the data processing system 20 to the modem circuitry 14.

Utilizing the current invention, the modem circuitry 14 can be isolated from the antenna 12 which may be electrically connected to earth ground. Furthermore, the modem circuitry 14 can receive electrical power from the data processing system 20 without requiring a separate isolation module.

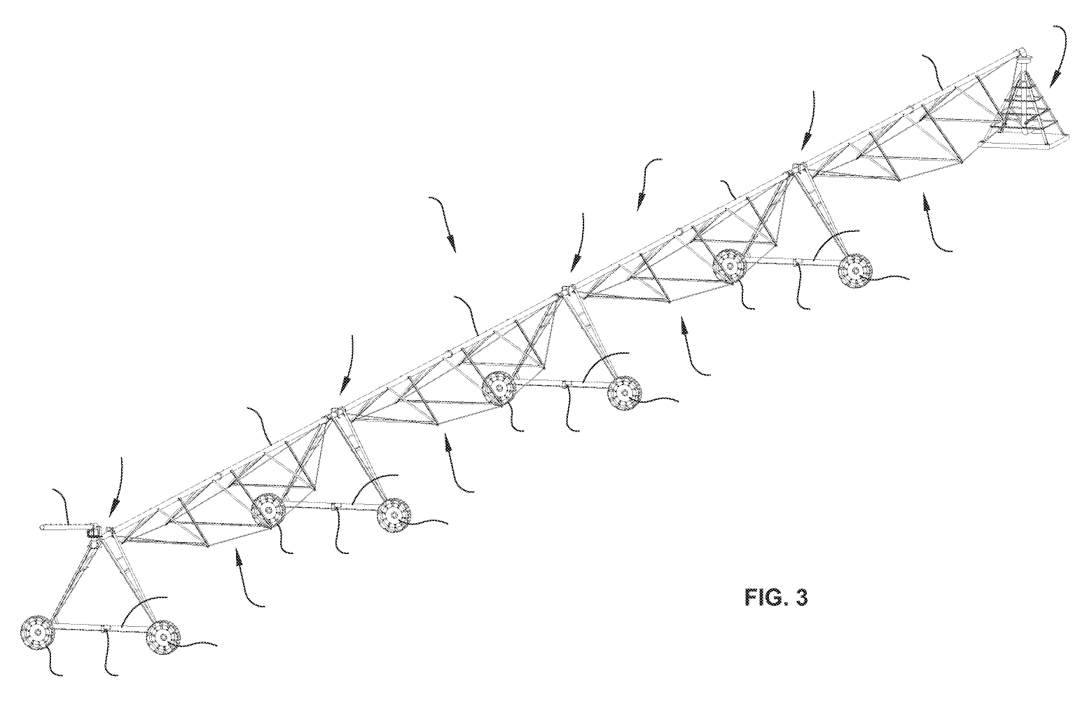

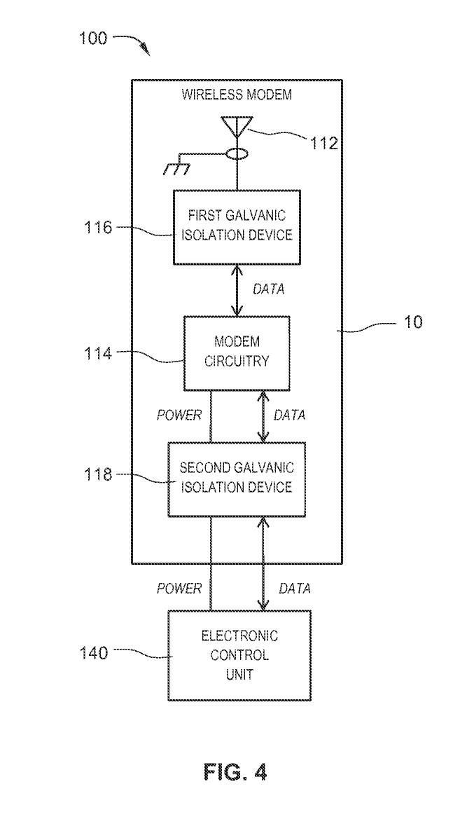

The above-described wireless modem may be used with an irrigation system 100 as shown in FIGS. 3 and 4. The irrigation system 100 may be a center pivot-type, which broadly comprises a wireless modem 110, a central pivot 122, a main section 124, a plurality of mobile support towers 126, and an electronic control unit 140. The irrigation system 100 may also be a lateral move type system or any other type of irrigation system.

As described above, the wireless modem 10 may include an antenna 112, modem circuitry 114, a first galvanic isolation device 116, and a second galvanic isolation device 118, which are each similar to the liked-named components of the wireless modem 10.

The fixed central pivot 122, as shown in FIG. 3, may be a tower or any other support structure about which the main section 124 may pivot. The central pivot 122 has access to a well, water tank, or other source of water and may also be coupled with a tank or other source of agricultural products to inject fertilizers, pesticides and/or other chemicals into the water for application during irrigation.

The main section 124 may comprise a number of mobile support towers 126A-D, the outermost 126D of which is referred to herein as an “end tower”. The support towers are connected to the fixed central pivot 122 and to one another by truss sections 128A-D or other supports to form a number of interconnected spans. The irrigation system 100 illustrated in FIG. 3 includes four mobile support towers 126A-D; however, it may comprise any number of mobile support towers without departing from the scope of the present invention.

Each mobile tower 126 may include a drive tube 130A-D on which a pair of wheel assemblies 132A-D is mounted. A drive motor 134A-D is mounted to each drive tube 130A-D for driving the wheel assemblies 132A-D. The motors 134A-D may include integral or external relays so they may be turned on, off, and reversed. The motors may also have several speeds or be equipped with variable speed drives.

Each of the truss sections 128A-D carries or otherwise supports a conduit section 136A-D or other fluid distribution mechanism that is connected in fluid communication with all other conduit sections and the central pivot 122. A plurality of sprinkler heads, spray guns, drop nozzles, or other fluid-emitting devices are spaced along the conduit sections 136A-D to apply water and/or other fluids to land underneath the irrigation system.

The irrigation system 100 may also include an optional extension arm (not shown) pivotally connected to the end tower 116D and supported by a swing tower with steerable wheels driven by a motor. The extension arm may be joined to the end tower by an articulating pivot joint. The extension arm is folded inward relative to the end tower when it is not irrigating a corner of a field and may be pivoted outwardly away from the end tower while irrigating the corners of a field.

The irrigation system 100 may also include one or more high pressure sprayers or end guns 138 mounted to the end tower 116D or to the end of the extension arm. The end guns 138 may be activated at the corners of a field or other designated areas to increase the amount of land that can be irrigated.

The electronic control unit 140 generally controls the operation of the components of the irrigation system 100 and may include processing elements, memory elements, circuitry to activate to the motors 134, circuitry to control fluid flow devices such as the end guns 138, circuitry to control the direction of the towers 126, and the like. In addition, the electronic control unit 140 may provide guidance or steering of the wheels 132A-D for embodiments of the irrigation system 100 which include steerable wheel assemblies 132. The electronic control unit 140 may include a control program, with instructions or commands that are typically stored in the memory element and executed by the processing element, that control the operations of the irrigation system 100. Occasionally, or at regular intervals, the electronic control unit 140 may receive changes or updates to the control program. Additionally, the electronic control unit 140 may receive command overrides or manual instruction input from an external source, such as an irrigation manager or a monitoring station. Furthermore, the electronic control unit 140 may transmit information to the external source regarding the performance of the irrigation system 100 such as the amount of time that the system has been operating or how much water has been used.

The electronic control unit 140 may be in communication with the wireless modem 110 in order to wirelessly transmit and receive data from the external source. Thus, data to be transmitted from the irrigation system 100 may be communicated from the electronic control unit 140 through the second galvanic isolation device 118 to the modem circuitry 114, which prepares the data to be transmitted wirelessly. The modem circuitry 114 may then communicate the data as an electronic transmit signal through the first galvanic device 116 to the antenna 112 to be transmitted. Data that is received by the irrigation system 100 may be communicated from the antenna 112 through the first galvanic isolation device 116 to the modem circuitry 114, which prepares the data for the electronic control unit 140. The modem circuitry 114 may then communicate the data through the second galvanic isolation device 118 to the electronic control unit 140.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A wireless modem comprising:
an antenna configured to transmit and receive wireless signals and to communicate electronic transmit and receive signals;
modem circuitry configured to convert transmit data from a data processing system to the electronic transmit signal for the antenna and to convert the electronic receive signal from the antenna to receive data for the data processing system;
a first galvanic isolation device configured to electrically isolate the electronic transmit and receive signals between the antenna and the modem circuitry; and
a second galvanic isolation device configured to receive electrical power from the data processing system and supply isolated electrical power to the modem circuitry and to electrically isolate the transmit and receive data between the modem circuitry and the data processing system.

2. The wireless modem of claim 1, wherein the second galvanic device includes an isolation transformer with a primary connected to the data processing system and a secondary connected to the modem circuitry.

3. An irrigation system comprising:
a central pivot coupled to a conduit configured to supply water for irrigating;
a plurality of mobile support towers in combination with a plurality of truss sections configured to support the conduit;
a plurality of drive motors configured to control the movement of the mobile support towers;
an electronic control unit including a program configured to control operation of the drive motors, the electronic control unit in communication with the wireless modem to transmit and receive data regarding the program; and
a wireless modem coupled to the electronic control unit and configured to wirelessly transmit data to and receive data from an external source for use by the program.

4. The irrigation system of claim 3, wherein the wireless modem includes an antenna configured to transmit and receive wireless signals and to communicate electronic transmit and receive signals.

5. The irrigation system of claim 4, wherein the wireless modem includes modem circuitry configured to convert transmit data from the electronic control unit to the electronic transmit signal for the antenna and to convert the electronic receive signal from the antenna to receive data for the electronic control unit.

6. The irrigation system of claim 5, wherein the wireless modem includes a first galvanic isolation device configured to electrically isolate the electronic transmit and receive signals between the antenna and the modem circuitry.

7. The irrigation system of claim 6, wherein the wireless modem includes a second galvanic isolation device configured to receive electrical power from the electronic control unit and supply isolated electrical power to the modem circuitry and to electrically isolate the transmit and receive data between the modem circuitry and the electronic control unit.

8. An irrigation system comprising:
a central pivot coupled to a conduit configured to supply water for irrigating;
a plurality of mobile support towers in combination with a plurality of truss sections configured to support the conduit;
a plurality of drive motors configured to control the movement of the mobile support towers;
an electronic control unit including a program configured to control operation of the drive motors, the electronic control unit in communication with the wireless modem to transmit and receive data regarding the program; and
a wireless modem coupled to the electronic control unit and configured to wirelessly transmit data to and receive data from an external source for use by the program, the wireless modem including
an antenna configured to transmit and receive wireless signals and to communicate electronic transmit and receive signals,
modem circuitry configured to convert transmit data from the electronic control unit to the electronic transmit signal for the antenna and to convert the electronic receive signal from the antenna to receive data for the electronic control unit,
a first galvanic isolation device configured to electrically isolate the electronic transmit and receive signals between the antenna and the modem circuitry, and
a second galvanic isolation device configured to receive electrical power from the electronic control unit and supply isolated electrical power to the modem circuitry and to electrically isolate the transmit and receive data between the modem circuitry and the electronic control unit.
